(19) United States
(12) Patent Application Publication
(10) Pub. No.: US 2022/0126257 A1
(43) Pub. Date: Apr. 28, 2022

(54) Synthesis of Nanoparticles by Sonofragmentation of Ultra-Thin Substrates

(71) Applicant: Massachusetts Institute of Technology, Cambridge, MA (US)

(72) Inventors: Ruixuan Gao, Cambridge, MA (US); Ishan Gupta, Cambridge, MA (US); Edward S. Boyden, Chestnut Hill, MA (US)

(73) Assignee: Massachusetts Institute of Technology, Cambridge, MA (US)

(21) Appl. No.: 17/464,651

(22) Filed: Sep. 1, 2021

Related U.S. Application Data
(63) Continuation of application No. 15/586,246, filed on May 3, 2017.
(60) Provisional application No. 62/331,367, filed on May 3, 2016.

(51) Int. Cl. B01J 19/10; B82Y 40/00; C01B 33/02

(52) U.S. Cl. CPC B01J 19/10; C01B 33/02; B82Y 40/00

(57) ABSTRACT

A method for synthesizing nanoparticles by sonofragmentation includes dispersing ultra-thin substrate units in a solvent chosen for suitability for sonofragmentation of the substrate, forming a suspension; ultrasonicating the suspension for a length of time sufficient to fragment the substrate into nanoparticles that are dispersed in the solvent; and evaporating the solvent. Solvent exchange with a second solvent may be performed. The synthesized nanoparticles are highly crystalline and monodispersed. The surface of the synthesized nanoparticles may be functionalized by choosing the solvents according to chemistry related to the intended surface functionalization of the synthesized nanoparticles, by adding surfactants to one or more of the solvents, and/or by performing ligand exchange or chemical modification to replace surface-bonded solvent or surfactant molecules with other functional groups to produce nanoparticles having the desired surface functionalization.

### RELATED APPLICATIONS

This application is a continuation of U.S. patent application Ser. No. 15/586,246, filed May 3, 2017, which claims the benefit of U.S. Provisional Application Ser. No. 62/276,781, filed May 3, 2016, the entire disclosures of which are herein incorporated by reference.

### STATEMENT REGARDING FEDERALLY SPONSORED RESEARCH OR DEVELOPMENT

This invention was made with U.S. government support under Grant Number W911NF1510548, awarded by the Department of Defense, Grant Number CBET1053233, awarded by the National Science Foundation, and Grant Number 5DP1NS087724, awarded by the National Institutes for Health. The government has certain rights in this invention.

### FIELD OF THE TECHNOLOGY

The present invention relates to synthesis of nanoparticles and, in particular, to synthesis of nanoparticles by sonofragmentation of ultra-thin substrates.

### BACKGROUND

Small (<10 nm) nanoparticles (NPs) are important because of the unique physical and chemical properties that arise due to their small size and large surface area. A multitude of methods have been developed to produce such nanoparticles, but most methods of synthesis of ultrasmall nanoparticles are impractical for general lab scale synthesis. Therefore, a simple and inexpensive method for top-down synthesis of nanoparticles would be potentially of both scientific and commercial interest. Ideally, extremely monodisperse nanoparticles of small size and high yield could be produced on regular benchtop equipment on site.

Synthesis of ultrasmall nanoparticles has heretofore been pursued with both top-down and bottom-up approaches [O. Masala and R. Seshadri, “Synthesis routes for large volumes of nanoparticles”, Annu. Rev. Mater. Res., 2004, 34, 41-81; D. Vaughn and R. Shaak, “Synthesis, properties and applications of colloidal germanium and germanium-based nanomaterials”, Chem. Soc. Rev., 2013, 42, 2861-2879]. In general, synthesis of small nanoparticles (<10 nm) has been limited to gas-phase and liquid phase approaches that require expensive machines, and top-down approaches that do not yield monodisperse crystalline nanoparticles.

Top-down approaches, such as laser-ablation, ball-milling, and electrochemical etching, have offered high-throughput syntheses of nanoparticles, but require specialized instrumental set-ups such as a femto-second laser or a milling chamber. Fragmentation of large particles or electrochemically defined patterns can be implemented in a conventional wet lab setting, but the particle size distribution obtained is large and the particles require post purification, which is typical for most top-down methods. Top-down synthesis methods that rely on breaking down bulk materials into smaller fragments can be scalably deployed. However, the method struggles with monodispersity and with percent yield for such small nanoparticles.

Bottom-up synthesis methods can effectively assemble small molecule precursors into larger units to create small nanoparticles. Bottom-up approaches, including solid-phase, gas-phase, and liquid-phase syntheses have offered a powerful synthetic pathway to highly-monodispersed nanoparticles of varied sizes. Solid-phase synthesis has enabled high-throughput and pure synthesis of nanoparticles. However, these methods commonly require specialized chemical or physical set-ups, including harsh chemicals and specialized equipment, for post-synthetic chemical processing, purification, and/or thermal processing, in addition to niche expertise for the synthesis, which renders the whole synthesis lengthy and costly, and therefore out of reach for many end users.

Since their first introduction in the early 20th century, ultrasonic waves have been used for underwater detection, real-time locating systems, medical diagnostics, and, more recently, production and dispersion of nanomaterials. The acoustic cavitation induced by ultrasound can break down macroscopic structures into pieces of nanoscopic lengths, but the method has often suffered from lack of morphological control and versatility, as exemplified by its low monodispersity and limitation in material choice.

Recently, sonofragmentation has excited substantial attention for its facile generation of nanoparticles. For instance, ultrafine nanoparticle production has been achieved with short-term and powerful ultrasonication of larger particles and bulk materials [J. Ali, G. U. Siddiqui, K. H. Choi, Y. Jang, and K. Lee, “Fabrication of blue luminescent MoS₂ quantum dots by wet grinding assisted co-solvent sonication”, Journal of Luminescence, 2016, 169, 342-347; B.W. Zeiger and K. S. Suslick, “Sonofragmentation of Molecular Crystals”, J. Am. Chem. Soc., 2011, 133 (37), 14530-14533; M. A. Basith, D.-T Ngo, A. Quader, M. A. Rahman, B. L. Sinha, Bashir Ahmmas, Fumihiko Hirose, and K. Molhave, “Simple top-down preparation of magnetic Bi_{0.9}Gd_{0.1}Fe₁₋ₓTiₓO₃ nanoparticles by ultrasonication of multiferroic bulk material”, Nanoscale, 2014, 6, 14336]. These methods, however, typically reply on an additional step of milling or grinding prior to the ultrasonication. In addition, the particle size distribution obtained by these methods is typically large and therefore the method requires size selection via centrifugation, chromatography, or other techniques.

Other recent studies [Y. Y. Huang, T. P. J. Knowles and E. M. Terentjev, Adv. Mater., 2009, 21, 3945-3948; A. Lucas, C. Zakri, M. Maugey, M. Pasquali, P. Van Der Schoot and P. Poulin, J. Phys. Chem. C, 2009, 113, 20599-20605; J. Stegen, J. Chem. Phys., 2014, 140; M. Park, Y. Sohn, W. G. Shin, J. Lee and S. H. Ko, Ultrason. Sonochem., 2015, 22, 35-40; H. B. Chew, M.-W. Moon, K. R. Lee and K.-S. Kim, Proc. R. Soc. A Math. Phys. Eng. Sci., 2010, 467, 1270-1289] show ultrasonication can be used to break down nanowires into shorter nanowires, and nanotubes into shorter nanotubes. The final yield of the nanoparticle synthesis depends on the yield and supply of the starting materials, some of which require specialized equipment and precursors.

### SUMMARY

The invention is a facile and versatile method for synthesizing nanoparticles and nanorods composed of various kinds of materials, such as, but not limited to, semiconductors, oxides, and metals. In a preferred embodiment, the present invention is a method of nanoparticle synthesis based on sonofragmentation of ultra-thin 1-Dimensional (1-D) substrates. The method generates ultra-small semiconductive nanoparticles or nanorods by combining bottom-up synthesized ultra-thin 1-D substrates with mechanical fragmentation facilitated by ultrasonication. The generated fragmented nanoparticles are highly crystalline and monodispersed, representing a major improvement over those obtained with previous sonofragmentation methods. The nanoparticle surface is terminated by covalently bound amide molecules and can be further redispersed in other solvents.

In one example application, germanium (Ge) nanoparticles are synthesized by sonofragmentation of ultrathin Ge nanowires. The method yields Ge nanoparticles of high purity, crystallinity, and monodispersity, which presents substantial advantage over conventional top-down methods and some of the bottom-up methods. The method can be generalized for use with other 1-D nanostructures, such as, but not limited to, silicon (Si), oxide, and metal nanowires.

The facile, bench-top synthesis of the invention makes it an ideal method for nanoparticle production at laboratory scale. In comparison to previous methods, sonofragmentation does not require advanced or expensive equipment, but rather only a bench-top ultrasonicator. In addition, the sonofragmentation method yields nanoparticles with high monodispersity and yield, which is a significant improvement over conventional top-down approaches. The synthesized nanoparticles can be resuspended in other solvents using a rotary evaporator, and can have surface functionalization of desired solvents. The surface functional groups can be further exchanged to other desired terminal functional groups, eliminating or significantly reducing the post-synthetic processes required in most bottom-up methods.

Short-term ultrasonication of high-aspect ratio 1D substrates rapidly generates highly-monodisperse nanoparticles, and subsequent longer-term ultrasonication results in ultrasmall nanoparticles. The method opens up a new approach, implementable with a bench-top ultrasonicator, for synthesis of nanoparticles of high purity, crystallinity and monodispersity. Thus, the invention democratizes small nanoparticle production, potentially opening up doors in a variety of fields that would benefit from the use of small nanoparticles for their chemical and physical properties.

In one aspect, the invention is a method for synthesizing nanoparticles or nanorods by sonofragmentation that includes the steps of dispersing at least one ultra-thin substrate unit in a first solvent to form a suspension, the first solvent being chosen according to suitability for sonofragmentation of the substrate; ultrasonicating the suspension for a length of time sufficient to fragment the substrate unit, producing a plurality of single nanoparticles or nanorods dispersed in the solvent; and evaporating the solvent to obtain the synthesized nanoparticles or nanorods. The method may include performing solvent exchange with a second solvent to produce a solution of synthesized nanoparticles or nanorods dispersed in the second solvent. At least one surfactant may be added to the first or second solvent in order to surface functionalize the nanoparticles or nanorods. Ligand exchange or modification may be performed in order to modify the surface functionalization of the nanoparticles or nanorods. The substrate may be loose or attached to a wafer from which the substrate may be liberated by ultrasonicating the wafer-attached substrate unit in the first solvent for a length of time sufficient to liberate the substrate unit from the wafer.

In a preferred embodiment, the length of time of ultrasonicating is from 12 to 24 hours. In a preferred embodiment, the substrate unit is a nanowire. In some preferred embodiments, the substrate is selected from the group consisting of semiconductors, metals, oxides, single-crystalline materials, poly-crystalline materials, amorphous materials, magnetic materials, and superconductive materials.

In another aspect, the invention is a method for functionalizing the surface of the synthesized nanoparticles or nanorods by choosing the first or second solvent according to at least one chemistry related to the intended surface functionalization of the synthesized nanoparticles or nanorods and/or by performing chemical modification to replace any surface-bonded solvent molecules with other functional groups to produce the nanoparticles having predetermined surface functionalization. At least one surfactant chosen according to at least one chemistry related to the intended surface functionalization may be added into the suspension; and ultrasonication may be continued for a length of time sufficient to produce nanoparticles having at least one surface-bonded surfactant molecule; after which any surface-bonded surfactant molecule may also be replaced with other functional groups to produce the nanoparticles having predetermined surface functionalization.

### BRIEF DESCRIPTION OF THE DRAWINGS

Other aspects, advantages and novel features of the invention will become more apparent from the following detailed description of the invention when considered in conjunction with the accompanying drawings, wherein:

FIG. 1 is a schematic depicting fragmentation of a 1-Dimensional (1-D) nanostructure into nanoparticles, according to one aspect of the invention.

FIG. 2 is a schematic diagram of the process of sonofragmentation and the subsequent solvent exchange steps, according to one aspect of the invention.

FIGS. 3A-B through 11A-C depict various aspects of physical characterization of Ge nanoparticles generated by an example implementation of the invention, wherein:

FIG. 3A is a graph of size distribution of as-synthesized Ge nanoparticles in DMF and Ge nanoparticles 24 hours after the solvent exchange from DMF to water.

FIG. 3B is a graph of size distribution of the Ge nanoparticles after 18 hr ultrasonication of Ge nanowires in DMF at 10-20° C. and 60-65° C.

FIGS. 4A-B are transmission electron microscope (TEM) images of sonofragmented Ge nanoparticles on a carbon-coated copper grid, wherein FIG. 4B is a high resolution TEM image of one of the nanoparticles depicted in FIG. 4A.

FIG. 5 is a bar graph depicting size distribution of Ge nanoparticles, measured from the TEM images of FIGS. 4A-B.

FIG. 6 is an optical image of Ge nanoparticles in DMF and the blank DMF under 365 nm UV-illumination.

FIG. 7A is a graph of photoluminescence (PL) of Ge nanoparticles after 1, 4, 8, and 24 hours of sonofragmentation and solvent exchange to ethanol.

FIG. 7B is a graph of UV-vis absorbance spectrum of Ge NPs in DMF after 18 hr ultrasonication and photoluminescence (PL) in ethanol under 320 nm UV-illumination.

FIGS. 8A-C are graphs depicting the chemical characterization of Ge nanoparticles, wherein FIG. 8A depicts the Fourier Transform Infrared (FTIR) spectra of ethanol (as control), FIG. 8B depicts the FTIR spectra of Ge nanoparticles, and FIG. 8C depicts the FTIR spectra of Ge nanoparticles ultrasonicated in DMF for 24 hrs and resuspended in chloroform.

FIGS. 9A-C are scanning electron microscope (SEM) images of an ultrathin Ge nanowire (FIG. 9A) and fragments after 30 min (FIG. 9B) and 18 hrs (FIG. 9C) of continuous ultrasonication.

FIG. 10 is a graph of size distribution of Ge nanoparticles resulting from a comparison experiment employing ultrasonication of Ge nanopowder in DMF.

FIGS. 11A-C are SEM images of the comparison experiment using Ge nanopowder (FIG. 11A), showing the resulting fragments after 30 min (FIG. 11B) and 18 hrs (FIG. 11C) of continuous ultrasonication.

FIGS. 12 through 22A-B depict sonofragmentation of ultra-thin oxide, metal and semiconductor nanowires, including silicon (Si), gold (Au), silver (Ag), and titanium dioxide (TiO₂), according to example implementations of the invention, wherein:

FIG. 12 is a SEM image of Si nanowires.

FIG. 13A is a bar graph of size distribution of the Si nanoparticles measured with TEM (μ=10.8 nm, σ=2.2 nm , n=5).

FIG. 13B is a plot of size distribution of unfiltered Si nanoparticles, measured by DLS after 24 hours of sonofragmentation in DMF.

FIG. 14 is a graph of photoluminescence (PL) of Si nanoparticles after 24 hours of sonofragmentation and solvent exchange to ethanol.

FIGS. 15A-B are TEM images of Si nanoparticles on a carbon-coated capper grid after 24 hr ultrasonication of the nanowires in DMF, wherein FIG. 15B is a high resolution TEM image of one of the nanoparticles depicted in FIG. 15A.

FIG. 16 is a graph of size distribution of filtered (2 um filter) Au nanoparticles, measured by DLS after 18 hours of sonofragmentation in IPA.

FIG. 17 is a SEM image of Ag nanowires.

FIG. 18A is a bar graph of size distribution of the Ag nanoparticles measured with TEM.

FIG. 18B is a graph of size distribution of unfiltered Ag nanoparticles, measured by DLS after 24 hours of sonofragmentation in water.

FIGS. 19A-B are TEM images of Ag nanoparticles on a carbon-coated copper grid after 24 hr ultrasonication of the nanowires in water, wherein FIG. 19B is a high resolution TEM image of one of the nanoparticles depicted in FIG. 19A.

FIG. 20 is a SEM image of TiO₂ nanowires. Scale bar, 100 nm.

FIG. 21A is a bar graph of size distribution of the TiO₂ NPs measured with TEM.

FIG. 21B is a graph of size distribution of unfiltered TiO₂ nanoparticles, measured by DLS after 24 hours of sonofragmentation in water.

FIGS. 22A-B are TEM images of TiO₂ nanoparticles after 24 hr ultrasonication of the nanowires in water, wherein FIG. 22B is a high resolution TEM image of one of the nanoparticles depicted in FIG. 22A.

### DETAILED DESCRIPTION

The method of synthesizing nanoparticles according to the invention employs an ultrasonication process to fragment one-dimensional (1-D) substrates into ultra-small nanoparticles and nanorods under the presence of a solvent. The sonofragmentation process is typically carried out with a commercially available bench-top ultrasonicator for 12-24 hours, and generates highly-monodispersed and pure nanoparticles. Furthermore, the invention includes a method to exchange the solvent to other desired solvents, as well as a method to functionalize the nanoparticle surface during and after the sonofragmentation process by introducing surfactants and post-synthetic chemical modifications.

The facile and universal method for generating ultra-small nanoparticles and nanorods by long-term sonofragmentation of 1-D substrates marries the advantages of prior top-down and bottom-up approaches. The process can generate nanoparticles of various materials with ease, high purity, and monodispersity. With common laboratory equipment, ultra-thin nanowires are fragmented into nanoparticles of size determined by the nanowire width, resulting within hours in monodisperse, crystalline nanoparticles of <10 nm. This strategy is applicable to a wide diversity of semiconductor, oxide, and metal nanowires.

Nanowires of extreme aspect ratio can be ultrasonicated to generate nanoparticles. By choosing nanowires of high aspect ratios, and then applying ultrasonication, it is possible to perform top-down synthesis of many kinds of nanoparticle in effectively a single step. With a constant supply of the nanowires, the method enables scalable production of ultra-small nanoparticle production in large quantities. Such nanowire production can be realized by, for example, a catalyzed high-throughput gas phase synthesis with extremely high precursor efficiency and gram-scale yield [H.-J. Yang and H.-Y. Tuan, J. Mater. Chem., 2012, 22, 2215-2225].

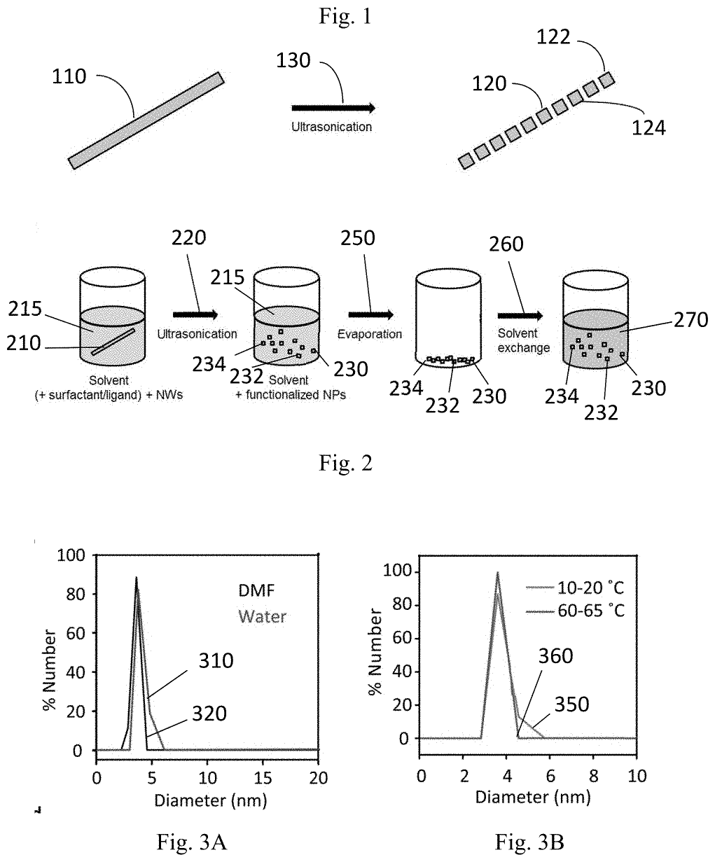

FIG. 1 is a schematic depiction of fragmentation of a 1-Dimensional (1-D) nanostructure 110 into nanoparticles 120, 122, 124 through ultrasonication 130. In one embodiment, the process starts with dispersing ultra-thin 1-D substrates in a solvent. The dispersion process depends on the initial form of the substrate, which is typically, but not limited to being, in powder form or attached to a wafer. For the powder, the desired solvent is added. For the wafer-attached case, the 1-D substrate is liberated using a short ultrasonication in the desired solvent. Subsequently, the suspension is ultrasonicated for 12-24 hours to fragment the 1-D substrate and produce single nanoparticles (NPs). Typically, the surface of these nanoparticles is functionalized with the solvent used. When a surfactant or more reactive ligand is added to the reaction, the surface of the nanoparticle is decorated by these molecules. The synthesized nanoparticles can be suspended in other types of solvents easily and be further modified using ligand exchange and ligand modification.

FIG. 2 is a schematic diagram of the process of sonofragmentation and the subsequent solvent exchange steps, according to this aspect of the invention. In FIG. 2, the process starts with dispersing ultra-thin 1-D substrate 210 in solvent 215. The suspension is ultrasonicated 220 for 12-24 hours to fragment substrate 210 and produce single nanoparticles 230, 232, 234 dispersed in solvent 215. Solvent 215 is evaporated 250, leaving single nanoparticles 230, 232, 234, followed by solvent exchange 260 with new solvent 270, producing a solution of nanoparticles 230, 232, 234 dispersed in solvent 270.

In one example application, germanium (Ge) nanoparticles were synthesized by sonofragmentation of ultrathin Ge nanowires. Starting with ultrathin Ge nanowires, sonofragmentation of the structure was carried out with a commercially available bench-top ultrasonicator. FIGS. 3A-B through 11A-C depict physical characterizations of, and related to, Ge nanoparticles generated according to this example implementation of the invention. The ultrasonication was carried out in DMF and the solvents were exchanged to ethanol (EtOH) for all the PL measurements.

Dynamic laser scattering (DLS) analysis of the as-synthesized Ge nanoparticles shows generation of highly monodispersed Ge nanoparticles of 3-4 nm diameters after sonofragmentation in N,N-dimethylformamide (DMF). FIG. 3A is a graph of the size distribution of as-synthesized Ge nanoparticles in DMF 310 and the size distribution of Ge nanoparticles 24 hours after the solvent exchange from DMF to water 320. Remarkably, one day after the exchange of solvents from DMF to water, the Ge nanoparticles still show similar monodispersity and size distribution. The observed stability in water thus indicates that the nanoparticle surfaces are likely functionalized by a polar functional group.

Consistent with the TEM analysis, monodisperse (polydispersity (Pd)=6.8%) Ge NPs of 2-5 nm diameters were generated after 18 hrs of ultrasonication, with no further purification. Temperature-controlled sonofragmentation experiments with two different temperature ranges of 10-20° C. and 60-65° C. were also carried out. FIG. 3B is a graph of size distribution of the Ge nanoparticles measured with dynamic laser scattering (DLS) after 18 hr ultrasonication of Ge nanowires in DMF at 10-20° C. 350 and 60-65° C. 360. The nanoparticle size was measured with dynamic laser scattering (DLS) in DMF. The results show that, within the range of concern, temperature had minimal effect on the synthesized nanoparticle size distribution.

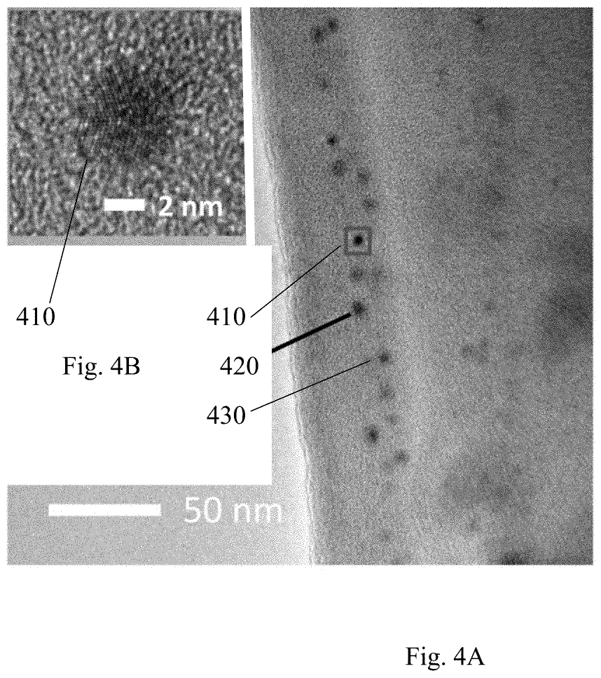

The Ge nanoparticles produced after 18 hrs of nanowire ultrasonication were analyzed using transmission electron microscopy (TEM). The as-synthesized Ge nanoparticles were resuspended in ethanol, filtered through a 0.2 μm filter to remove large debris and aggregates, and drop-casted and dried on a carbon-copper grid for TEM characterization. FIG. 4A is a transmission electron microscope (TEM) image of the sonofragmented Ge nanoparticles 410, 420, 430 on the carbon-coated copper grid (scale bar, 50 nm), with FIG. 4B showing a high resolution TEM image of Ge nanoparticle 410 (scale bar, 2 nm).

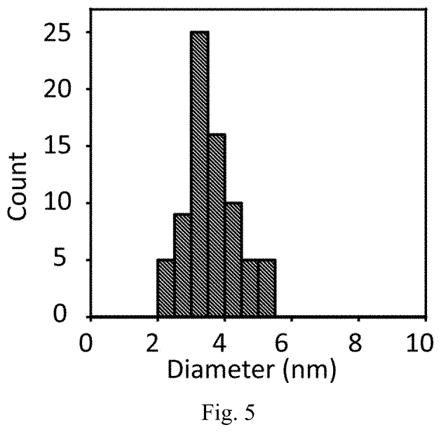

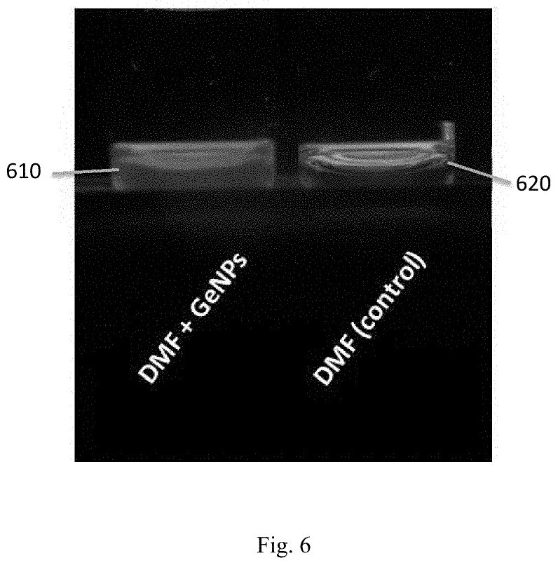

Analysis of the bright-field TEM images of FIGS. 4A-B shows the nanoparticles had an average size of 3.58 nm and a standard deviation of 0.74 nm (n=75 from a single TEM grid), confirming generation of ultrasmall (<10 nm) Ge NPs. FIG. 5 is a bar graph depicting the size distribution of the Ge nanoparticles, measured from the TEM images of FIGS. 4A-B. This result is consistent with the DLS size distribution of FIGS. 3A-B, further confirming generation of nanoparticles with 3-4 nm diameters.

The high-resolution TEM image of the Ge nanoparticle 410 in FIG. 4B shows that they are single crystalline, consistent with the crystallinity of the starting material. Imaging of a typical Ge nanoparticle shows clear lattice fringes, indicating a minimal amorphization effect during the long-term ultrasonication. The ˜0.20 nm spacing of lattice fringes corresponds to the spacing between (220) planes of Ge, consistent with the starting material of crystalline Ge nanowires. In addition to the 18 hrs ultrasonicated nanoparticles, Ge nanoparticles were also imaged with TEM after 30 min and 1 hr of ultrasonication. The results show a nanoparticle size change consistent with the previous SEM imaging.

Ge nanoparticle generation was also traced by its intrinsic photoluminescence (PL) under optical excitation. FIG. 6 is an optical image of Ge nanoparticles in DMF 610 and the blank DMF 620 (control) under 365 nm UV-illumination. The as-synthesized Ge nanoparticles in DMF 610 show a blue fluorescence under UV excitation.

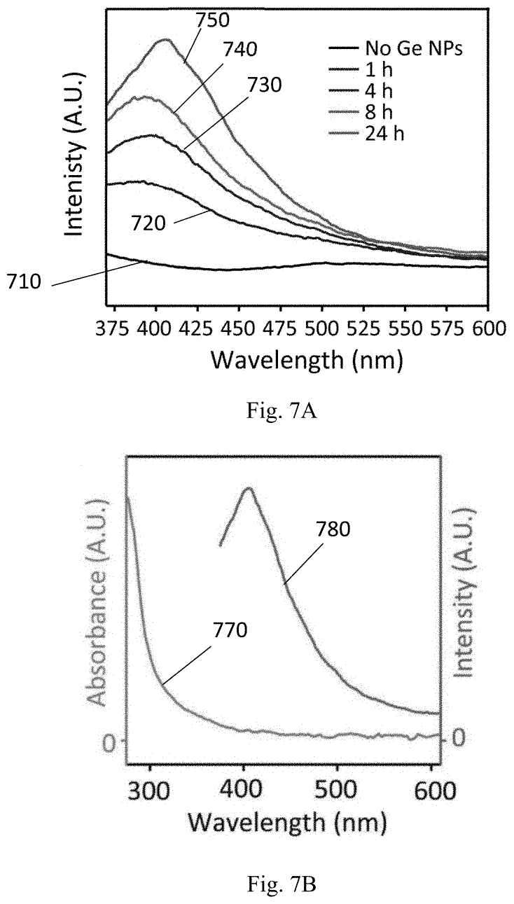

FIG. 7A is a graph of photoluminescence (PL) of a control 710 having no Ge nanoparticles and of generated Ge nanoparticles after 1 hour 720, 4 hours 730, 8 hours 740, and 24 hours 750 of sonofragmentation and solvent exchange to ethanol. Time-resolved PL measurements of the Ge nanoparticle suspension shows an increase of fluorescence around 400 nm wavelength as the sonication time increases, suggesting generation of increasing amount of Ge nanoparticles in the solution.

To investigate the optical properties of the synthesized Ge nanoparticles, the absorbance of the ultrasonicated sample was measured using a UV-vis spectrometer. FIG. 7B is a graph of UV-vis absorbance spectrum of Ge NPs in DMF after 18 hr ultrasonication 770 and photoluminescence (PL) in ethanol under 320 nm UV-illumination 780. For the PL measurement, the ultrasonication was carried out in DMF for 24 hrs and the Ge NPs were resuspended in ethanol. The Ge nanoparticles readily absorbed light with <400 nm wavelengths. The intrinsic photoluminescence (PL) of the Ge NPs under optical excitation was measured using a UV-vis spectrometer. The sample showed a characteristic PL peak around 410 nm wavelengths, consistent with previous reports. The blue emission observed can possibly arise from surface oxidation and absorption of molecules.

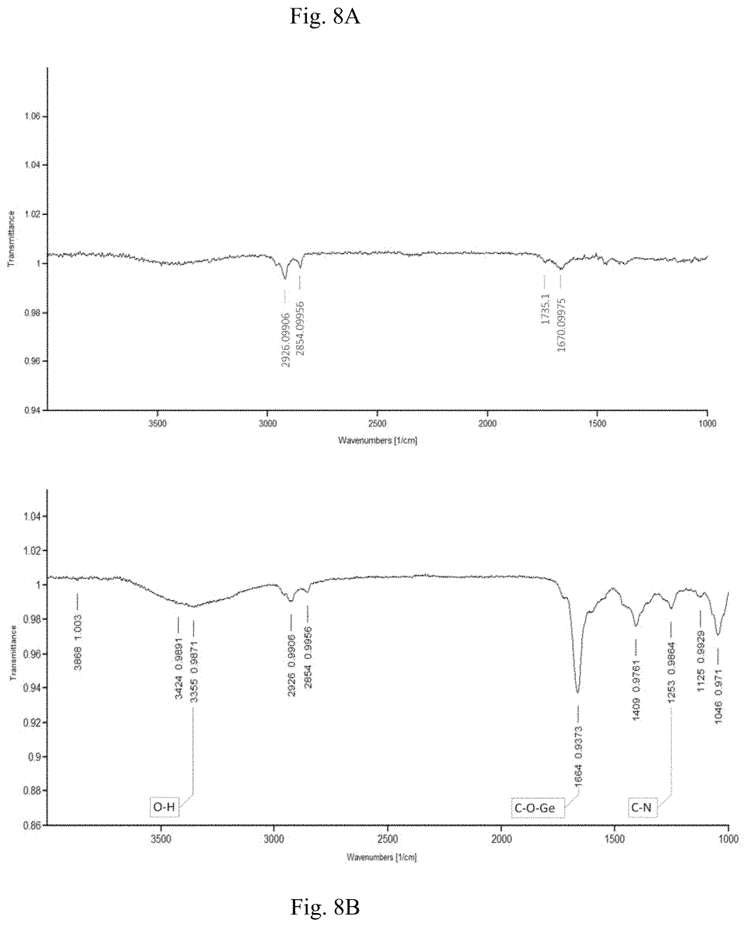

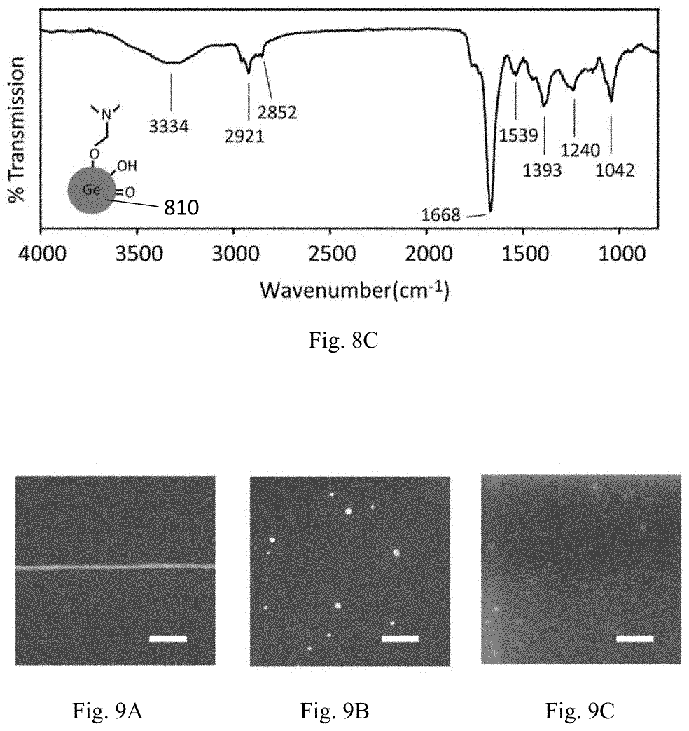

To study the surface of the synthesized Ge NPs, Fourier Transform Infrared (FTIR) spectroscopy was performed on the Ge nanoparticles produced by 24 hour sonication of Ge nanowires in DMF. FIGS. 8A-C are graphs depicting the chemical characterization of Ge nanoparticles, wherein FIG. 8A depicts the Fourier Transform Infrared (FTIR) spectra of ethanol (as control), and FIG. 8B depicts the FTIR spectra of Ge nanoparticles that were ultrasonicated in DMF and resuspended in ethanol. The surface of the as-synthesized Ge nanoparticles displays both free hydroxyls (3353.65 cm-1) and DMFs, which are chemisorbed onto the surface through a C—O—Ge (1666.71 cm-1) bridge. The surface functionalization was retained after solvent exchange to other solvents, including ethanol and water.

FIG. 8C depicts the FTIR spectra of Ge NPs ultrasonicated in DMF for 24 hrs, washed in chloroform three times, and resuspended in chloroform. The suspension was then drop-casted and air dried on the attenuated total reflectance (ATR) crystal before the FTIR measurements FIG. 8C includes a schematic 810 of possible functional groups on the Ge NP surface. The surface of the as-synthesized Ge NPs displayed both free hydroxyls (3334 cm-1) and DMFs, which are likely to be chemisorbed onto the surface through a C—O—Ge (1668 cm-1) bridge.

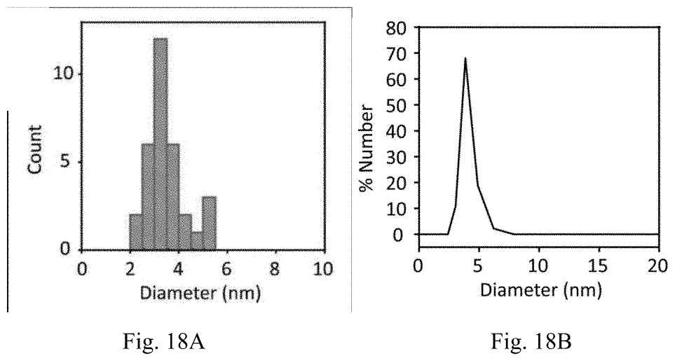

To perform the experiments, ultra-thin Ge nanowires (diameters tapering from ˜30 nm to ˜2 nm) were dispersed in DMF, and the suspension was ultrasonicated with a bench-top ultrasonicator (40 kHz, 110 W). To track fragmentation of the nanowires, the ultrasonicated sample was also imaged at different time points using scanning electron microscopy (SEM). FIGS. 9A-C are scanning electron microscope (SEM) images of an ultrathin Ge nanowire (FIG. 9A) and fragments after 30 min (FIG. 9B) and 18 hrs (FIG. 9C) of continuous ultrasonication (scale bars, 200 nm). The samples were resuspended in ethanol before drop-casted to a Si substrate for the SEM imaging. It was found that the nanowires readily fragmented into <30 nm particles within 30 minutes of ultrasonication. During the subsequent long-term ultrasonication, the particle size further decreased with increasing ultrasonication time. For instance, the majority of the nanoparticles had diameters of <10 nm with 18 hr ultrasonication.

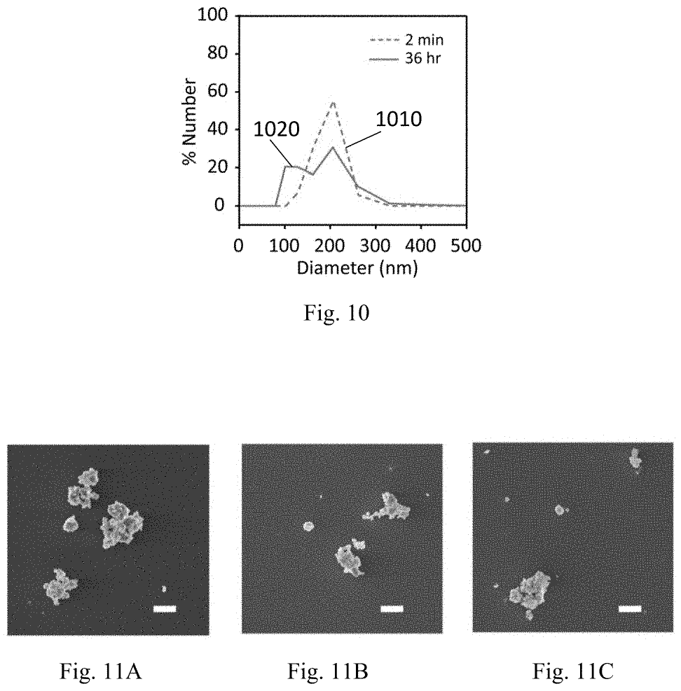

As a comparison, the same ultrasonication was carried out using a non-1D Ge substrate (100˜300 nm diameter nanopowder). FIG. 10 is a graph of the size distribution of Ge nanoparticles from nanopowder measured with DLS after 2 min 1010 and 36 hrs 1020 of ultrasonication of the Ge nanopowder in DMF. In comparison to the Ge nanowire substrate, the Ge nanopowder substrate showed similar nanoparticle size range and distribution before (Pd=16.2%) vs. after an ultrasonication time of 36 hrs (Pd=19.1%). This result confirms the advantage of using an ultra-thin 1D substrate to produce monodisperse ultrasmall nanoparticles.

FIGS. 11A-C are SEM images of the comparison experiment using Ge nanopowder (FIG. 11A), showing the resulting fragments after 30 min (FIG. 11B) and 18 hrs (FIG. 11C) of continuous ultrasonication in DMF (scale bars, 1 μm). The samples were resuspended in ethanol before drop-casted to a Si substrate for the SEM imaging. Contrary to the nanowires, the nanopowder did not show a clear change in particle size with increasing ultrasonication time. For instance, after 18 hrs of ultrasonication, ˜100-300 nm particles were observed to be in the majority, which is comparable to the size distribution of the starting material.

The method of the invention is compatible with a wide variety of types of ultrathin 1-D substrates, including, but not limited to, semiconductors, oxides, and metals. To assess whether the method could be applied to different types of ultra-thin 1D substrates, synthesis of nanoparticles using various commercially available nanowires was carried out. FIGS. 12 through 22A-B depict example applications of the method to sonofragmentation of ultra-thin oxide, metal and semiconductor nanowires, including silicon (Si), gold (Au), silver (Ag), and titanium dioxide (TiO₂), according to example implementations of the invention.

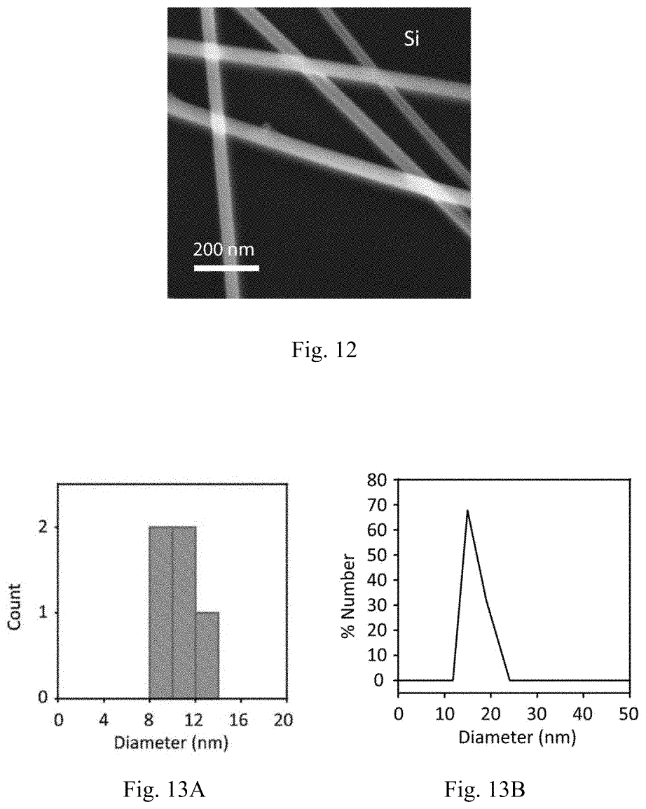

In one experiment, Si nanowires (nominal diameter of about 30 nm) were sonofragmented into nanoparticles using a similar procedure to that used for Ge nanowire sonofragmentation. FIG. 12 is a SEM image of Si nanowires (scale bar, 200 nm). Si nanowires were ultrasonicated in DMF for 24 hours. FIG. 13A is a bar graph of size distribution of the resulting Si nanoparticles measured with TEM (μ=10.8 nm, σ=2.2 nm , n=5). FIG. 13B is a plot of size distribution of unfiltered Si nanoparticles, measured by DLS after 24 hours of sonofragmentation in DMF.

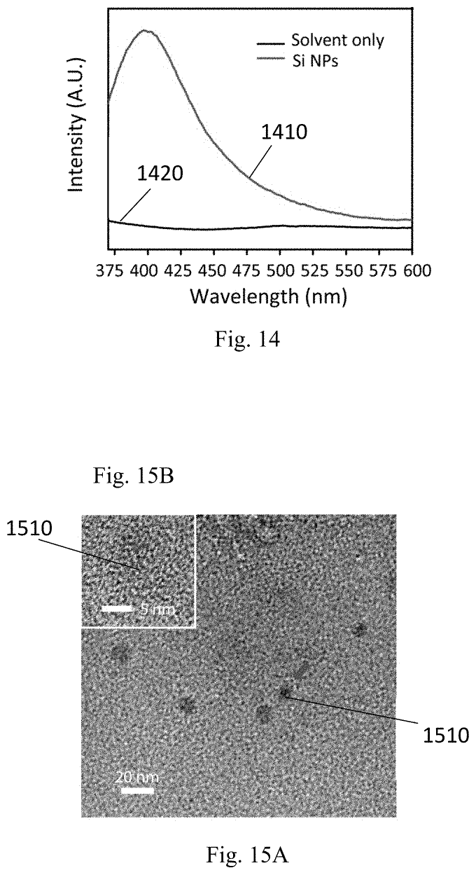

To characterize the optical properties of the synthesized Si nanoparticles, the PL of suspension was measured. Ultrasonication was carried out in DMF for 24 hrs and the solvent was exchanged to ethanol for the PL measurement. FIG. 14 is a graph of photoluminescence (PL) under 320 nm UV-illumination of Si nanoparticles 1410 after 24 hours of sonofragmentation and solvent exchange to ethanol, as compared to solvent only 1420. After solvent exchange from DMF to ethanol, the suspended nanofragments show signature PL spectra of Si nanoparticles. The results show a violet-blue fluorescence peak at around 400 nm in wavelength that is consistent with previous reports.

The Si nanoparticles were drop-casted on a TEM grid and were imaged to confirm the size distribution and single-crystallinity of the nanoparticles. FIGS. 15A-B are TEM images of Si nanoparticles after 24 hr ultrasonication of the nanowires in DMF, on a carbon-coated copper grid, with FIG. 15B being a high resolution TEM image (scale bar, 5 nm) of one of the nanoparticles 1510 depicted in FIG. 15A (scale bar, 20 nm). TEM analysis shows that the Si nanoparticles are crystalline and the average and standard deviation of the nanoparticle size are 10.8 nm and 2.2 nm, respectively. HRTEM image of a typical Si NP shows a ˜0.27 nm spacing between the lattice fringes, which likely corresponds to the spacing between planes of a diamond cubic lattice of silicon. In this particular image, the commonly observable fringes were not clearly resolved. To characterize the nanoparticle size in the solvent, the nanoparticle was measured size using DLS. The results show a monodisperse size distribution (Pd=11.5%) of ˜10-12 nm diameter, a range consistent with the TEM results of FIG. 13B.

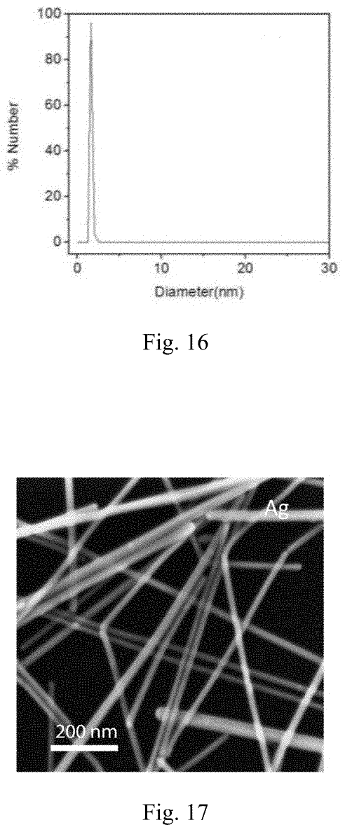

In addition to semiconductor material nanoparticles, oxide and metal nanoparticles were also synthesized using the method. In one instance, sonofragmentation of Au nanowires (nominal diameter of about 2 nm) in isopropanol (IPA) yielded highly monodispersed Au nanoparticles. FIG. 16 is a graph of size distribution of filtered (2 um filter) Au nanoparticles, measured by DLS after 18 hours of sonofragmentation in IPA.

In another example application of the method, ultrasonication of commercially available Ag nanowires (nominal diameter of about 20 nm) was carried out using the same sonofragmentation process. FIG. 17 is a SEM image of Ag nanowires (scale bar, 200 nm). Sonofragmentation of the Ag nanowires yielded a nanoparticle suspension with 2-6 nm size range. FIG. 18A is a bar graph of size distribution of the Ag nanoparticles measured with TEM (μ=3.46 nm, σ=0.75 nm and n=32). FIG. 18B is a graph of size distribution of unfiltered Ag nanoparticles, measured by DLS after 24 hours of sonofragmentation in water.

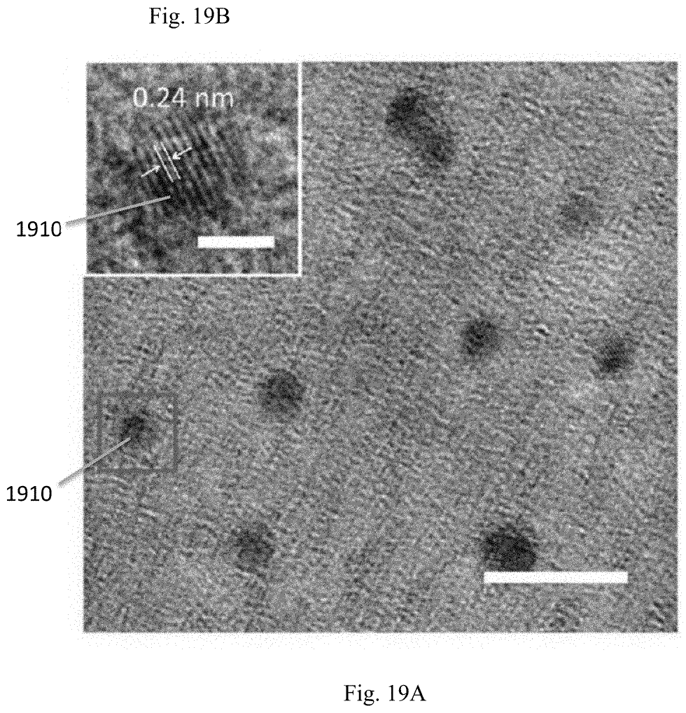

FIGS. 19A-B are TEM images of Ag nanoparticles on a carbon-coated copper grid after 24 hr ultrasonication of the nanowires in water, wherein FIG. 19B is a high resolution TEM image (scale bar, 2 nm) of one of the nanoparticles 1910 depicted in FIG. 19A (scale bar, 10 nm). TEM characterization shows the synthesized Ag NPs are crystalline and have average size and standard deviation of 3.46 nm and 0.75 nm, respectively. The HRTEM image of a typical Ag NP shows a lattice fringe spacing of ˜0.24 nm, consistent with the plane spacing of Ag. The nanoparticle size in the solvent was also measured, and the results show a monodisperse size distribution (Pd=15%) of ˜2-7 nm diameter, consistent with the TEM results of FIG. 18B.

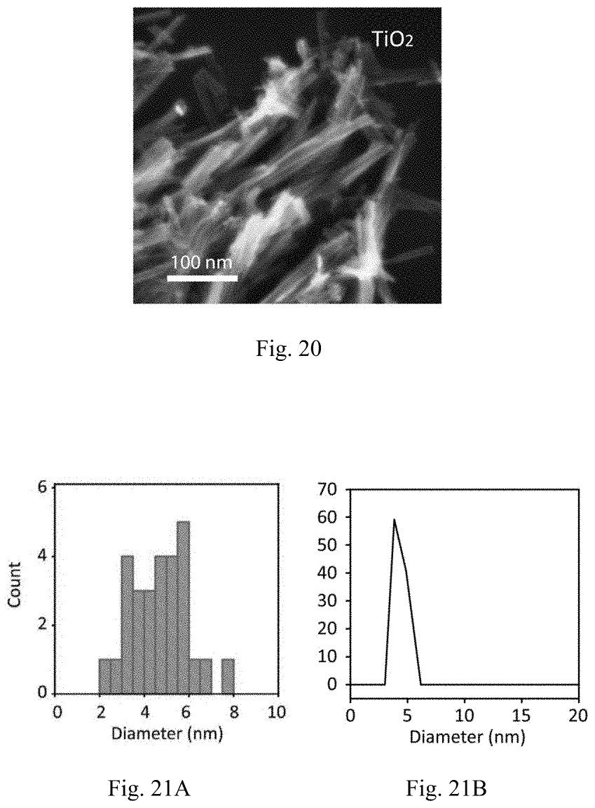

In another example application, ultrasonication of commercially available TiO₂ nanowires (nominal diameter of about 10 nm) was carried out in water for 24 hrs. FIG. 20 is a SEM image of TiO₂ nanowires (scale bar, 100 nm). Sonofragmented TiO₂ nanowires produced monodispersed and single crystalline TiO₂ nanoparticles in water. FIG. 21A is a bar graph of size distribution of the TiO₂ NPs measured with TEM (μ=4.63 nm, σ=1.28 nm, n=27). FIG. 21B is a graph of size distribution of unfiltered TiO₂ nanoparticles, measured by DLS after 24 hours of sonofragmentation in water.

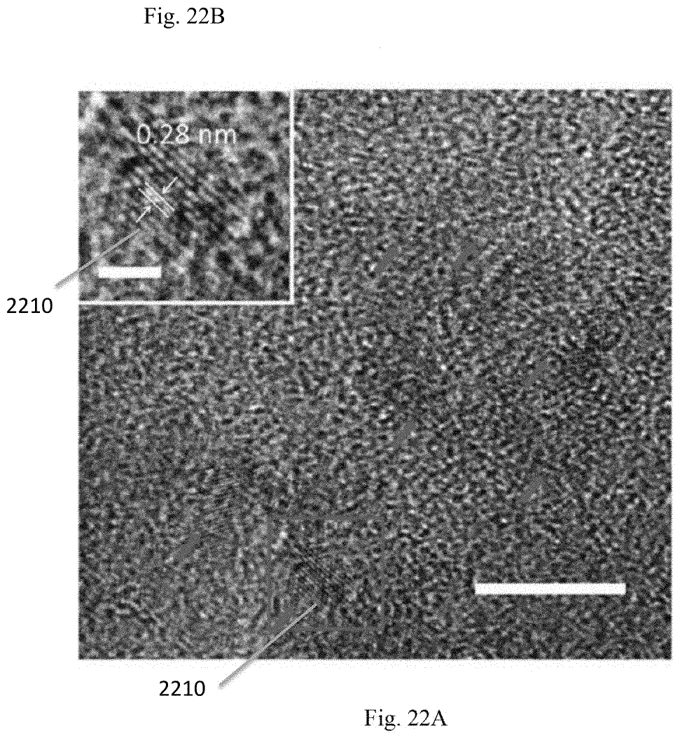

FIGS. 22A-B are TEM images of TiO₂ nanoparticles after 24 hr ultrasonication of the nanowires in water, wherein FIG. 22B is a high resolution TEM image (Scale bar, 2 nm) of one of the nanoparticles 2210 depicted in FIG. 22A (scale bar, 10 nm). TEM analysis shows that the average and standard deviation of the nanoparticle size are 4.63 nm and 1.28 nm, respectively, confirming generation of nanoparticles of <10 nm diameter. HRTEM imaging of a typical TiO₂ nanoparticle 2210 shows clear lattice fringes, indicating that the nanoparticles are crystalline (FIG. 22B). The ˜0.28 nm spacing between fringes is consistent with the spacing between planes of rutile TiO₂. The TiO₂ nanoparticles in the solvent were characterized and found to have a monodisperse size distribution (Pd=11%) of ˜3-6 nm diameter, a range consistent with the TEM results of FIG. 21B.

Based on previous theoretical and experimental studies of ultrasonication, it appears that the effects of long-term and continuous sonofragmentation on ultra-thin nanowires are both physical and chemical. In a previous study that used a theoretical model to calculate the tensile stress applied by a cavitation bubble, the tensile stress on a 1D nanostructure is shown to be dependent on the ratio of its diameter to its length [S. K. Bux, M. Rodriguez, M. T. Yeung, C. Yang, A. Makhluf, R. G. Blair, J. P. Fleurial and R. B. Kaner, Chem. Mater., 2010, 22, 2534-2540]. The model suggests that thinner and longer nanowire and nanotube substrates can be more easily broken into fragments compared with substrates of low aspect ratio [Y. Y. Huang, T. P. J. Knowles and E. M. Terentjev, Adv. Mater., 2009, 21, 3945-3948]. In another mechanical study, it had been predicted and shown that, for the case of carbon nanotubes, shorter nanofragments are produced with increasing sonication times [A. Lucas, C. Zakri, M. Maugey, M. Pasquali, P. Van Der Schoot and P. Poulin, J. Phys. Chem. C, 2009, 113, 20599-20605]. Nanoparticle generation from ultrasonication of high aspect ratio nanowires according to the method of this invention is consistent with these predictions and observations. Aside from mechanical fragmentation of nanowires, significant local heating up to a few thousand Kelvin near cavitation bubbles can be another cause of nanowire fragmentation [W. B. McNamara, Y. T. Didenko and K. S. Suslick, Nature, 1999, 401, 772-775]. Previous studies have shown that metal and semiconductor nanowires, driven by the Plateau-Rayleigh instability, readily form a string of nanospheres when heated [H. Y. Peng, Z. W. Pan, L. Xu, X. H. Fan, N. Wang, C. S. Lee and S. T. Lee, Adv. Mater., 2001, 13, 317-320; R. W. Day, M. N. Mankin, R. Gao, Y.-S. No, S.-K. Kim, D. C. Bell, H.-G. Park and C. M. Lieber, Nat. Nanotechnol., 2015, 10, 345-352]. The thermal instability of ultra-thin nanowires could in principle therefore be another physical route for nanoparticle generation during ultrasonication.

From a chemical point of view, surface functionalization of the nanoparticles plays an important role in dispersing and stabilizing nanoparticles in solvents during the sonofragmentation [M. Y. Tsai, C. Y. Yu, C. C. Wang and T. P. Perng, Cryst. Growth Des., 2008, 8, 2264-2269; T. Hanrath and B. A. Korgel, J. Am. Chem. Soc., 2004, 126, 15466-15472]. For instance, the FTIR analysis of the ultrasonicated Ge nanoparticles suggests that the surfaces of nanoparticles are terminated with DMF molecules with the CO groups coordinating to the Ge atoms. It is suspected that these surface coordinated solvent molecules stabilize nanoparticles and prevent them from fast oxidation and decomposition. In addition, the partially positive charge on the nitrogen terminal is likely to prevent the Ge nanoparticles from aggregating in polar solvents such as DMF and ethanol, thus keepinh the nanoparticles dispersed in these solvents.

The time-evolution results on the Ge fragments further provides insight into possible mechanism of nanoparticle generation during sonofragmentation. During the initial phase of the ultrasonication, the Ge nanowires rapidly fragment into <30 nm particles. This process is complete within ˜30 minutes which is likely due to the high aspect ratio of the nanowire substrate. Increasing the ultrasonication time further reduces the size of these particles such that with 18 hrs of ultrasonication, the size range decreases to 3-5 nm.

A number of combinations of substrates, solvents, surfactants, ligands pairings were tested and shown to be suitable for use in various embodiments of the invention, as shown in Table 1

TABLE 1

| Substrate | Solvent | Surfactant | Ligand |
|---|---|---|---|
| Ge | Dimethylformamide (DMF), | | (3- |
| | Dimethyl Sulfoxide (DMSO), | | Aminopropyl)trimethoxysilane |
| | Toluene, Hexanes, 35% | | (APTMS) + EtOH, Urea + |
| | Hydrochloric acid (HCl) in | | MeOH; Tris Base + water, |
| | water, HCl (1M) in dioxane, | | Octylamine + toluene, |
| | water, Ethanol (EtOH), | | Octylamine + Hexanes, |
| | Methanol (MeOH), Ethylene | | Mercaptopropionic acid + water, |
| | DIamine (EDA) | | 1-octanethiol + toluene |
| Si | DMF | | |
| Ag | Water, Isopropyl alcohol | | Sodium citrate + Water |
| Au | Water, Isopropyl alcohol | | Sodium citrate + Water |
| TiO2 | Water, DMF | | |
| Al2O3 | Water, DMF | | |
| FeO | Water | | |
| MnO | Water | | |

Based on these results, it is clear to one of skill in the art of the invention that at least the combinations shown in Table 2 will also be suitable for use in various embodiments of the invention.

TABLE 2

| Substrate | Solvent | Surfactant | Ligand |
|---|---|---|---|
| Ge | Hydrogel | Surfactants used for reverse | Thiol based ligands (e.g. |
| | peroxide | emulsion synthesis: TOAB | dodecanethiol, |
| | (H2O2) in | (tetraoctyl ammonium | mercaptopropionic acid, |
| | water, | bromide), C12E5, CTAB | thioglycolic acid, thyoglycerol) |
| | Hydrogel | | Amine based ligands (e.g. |
| | fluoride (HF) | | ethylenediamine, tris, |
| | in water | | octylamine, Hexadecylamine) |
| | | | Carbonyl based ligands (e.g. |
| | | | DMF, Acetone) |
| | | | Chlorine based ligands (e.g. |
| | | | Chloroalkanes) |
| | | | Siloxanes and Silanes (e.g. |
| | | | APTMS) |
| Si | Same as Ge | Same as Ge | Same as Ge |
| Ag | DMF, DMSO, | Surfactants used for reverse | Thiol based ligands |
| | Toluene, | emulsion synthesis: SDS, | |
| | Hexane (in the | CTAB etc | |
| | presence of | | |
| | thiol based | | |
| | ligands) | | |
| Au | Same as Ag | SDS, CTAB etc | Thiol based ligands |
| TiO2 | Water, | SDS, CTAB etc | Siloxanes based ligands |
| | alcohols, | | |
| | acetone, | | |
| | toluene, | | |
| | Hexanes | | |
| | (based on the | | |
| | siloxane being | | |
| | used) | | |
| Al2O3 | Same as TiO2 | Same as TiO2 | Siloxanes based ligands |
| FeO | Same as TiO2 | Same as TiO2 | Siloxanes based ligands |
| MnO | Same as TiO2 | Same as TiO2 | Siloxanes based ligands |

Sonofragmentation. All the sonofragmentation was carried out using a bench-top bath ultrasonicator (40 kHz, max sonication power 110 W, Bransonic Ultrasonic Baths, Thomas Scientific). Starting materials in powder or suspended form (including, but not limited to, TiO₂ nanowires, Sigma-Aldrich; Ag nanowires, Novarials Corp.; Ge nanopowder, SkySpring Nanomaterials, Inc.) were added directly to an amber glass vial (4 ml, Sigma-Aldrich) with the solvents for the ultrasonication and were ultrasonicated for 12-24 hours. Starting materials attached to a wafer substrate were first gently sonicated in the solvent for 2 minutes, and then the supernatant was transferred to another amber glass vial for the subsequent ultrasonication. The bath temperature of the ultrasonicator was not actively controlled unless otherwise noted. The temperature typically increased from about 25° C. to about 60° C. for the18 hr ultrasonication. Active control of temperature was achieved by using a chiller (RC2 Basic, IKA) and the internal heating system of the ultrasonicator for the temperature range of 10-20° C., and 60-65° C., respectively.

Transmission Electron Microscope (TEM) and Scanning Electron Microscope (SEM) Characterizations. TEM characterization of the nanoparticles (NPs) was carried out using a JEM-2100 TEM (JEOL). The as-synthesized nanoparticles were (re)suspended in ethanol (for Ge, TiO₂ and Si NPs) or water (for Ag NPs) before being filtered through a 0.2 μm filter to remove large aggregates and debris. The suspension was then drop-casted on a carbon-copper grid (Ted Pella, Inc.), and dried in a vacuum desiccator for 20 min. The imaging was carried out at 200 keV under bright-field illumination. SEM characterization of the nanowires and fragments was carried out using an UltraPlus FE-SEM (Zeiss) with an inlens detector.

Dynamic Laser Scatterer (DLS) Characterization. DLS characterization of the nanoparticles was carried out with a dynamic light scattering instrument (DynaPro NanoStar, Wyatt Technology Corp.). About 100 uL of the sample was transferred to a disposable cuvette (Wyatte Technology Corp.) for the DLS measurement. The final histogram of nanoparticle size distribution was generated from 10 measurements for each sample.

Photoluminescence (PL) and UV-vis Absorption Characterization. PL characterization of the nanoparticles was carried out using a fluorescence spectrometer (Cary Eclipse, Agilent). About 40 ul of the sample was transferred to a quartz cuvette (Sigma-Aldrich) for the fluorescence measurement. UV-vis spectra of the nanoparticles were measured using a bench-top UV-vis spectrometer (NanoDrop 2000, ThermoFisher).

Fourier Transform Infrared (FTIR) Characterization. FTIR characterization of the Ge NPs was carried out using an FTIR spectrometer (SpectrumOne, Perkin Elmer). After 18 hrs of ultrasonication in DMF, the nanoparticles were dried under vacuum and resuspended in chloroform for three times to completely remove the DMF. The nanoparticle suspension was then drop-casted onto the attenuated total reflection (ATR) crystal of the FTIR spectrometer and air-dried for 15 min before the measurement. The FTIR measurement was carried out for 3 min and the baseline was automatically corrected.

Nanowire Synthesis. Ge and Si nanowires were synthesized with vapor-liquid-solid (VLS) growth mechanism using published protocols.^{44, 50, 51} Briefly, Ge nanowires were grown with 2 nm gold nanocatalyst for 150 min using GeH₄ (2 sccm) and H₂ (18 sccm) at total pressure of 400 torr and temperature of 270° C. Si nanowires were grown for 60 min with 30 nm gold nanocatalyst using SiH₄ (2.5 sccm) and H₂ (60 sccm) at total pressure of 40 torr and temperature of 450° C.

In one aspect, the invention includes, but is not limited to, a novel method for synthesizing nanoparticles and nanorods by sonofragmentation of substrates, including (a) semiconductors, metals, and oxides; (b) single-crystalline, poly-crystalline, and amorphous materials; and (c) magnetic and superconductive materials. In another aspect, the invention includes, but is not limited to, a novel method for in-situ or post-synthetic surface functionalization of synthesized nanoparticles or nanorods by:

(a) sonofragmenting the substrates in desired solvents;

(b) sonofragmenting the substrates with desired surfactants; and

(c) chemical modification to replace the surface-bonded solvent or surfactant molecules with other functional groups.

While preferred embodiments of the invention are disclosed herein, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention.

What is claimed is:

1. A method for synthesizing nanoparticles by sonofragmentation, comprising the steps of:
dispersing at least one ultra-thin one-dimensional substrate unit, comprising a high-aspect ratio nanowire, in a first solvent to form a suspension, the first solvent being chosen according to suitability for sonofragmentation of the substrate;
ultrasonicating the suspension for a length of time sufficient to fragment the at least one substrate unit into nanoparticles, producing a plurality of single nanoparticles dispersed in the solvent; and
after the step of ultrasonicating, evaporating the solvent to obtain the nanoparticles.

2. The method of claim 1, further comprising the step of, after the step of evaporating, performing solvent exchange with a second solvent to produce a solution of the nanoparticles dispersed in the second solvent.

3. The method of claim 1, further comprising the step of adding at least one surfactant to the first solvent in order to surface functionalize the nanoparticles.

4. The method of claim 3, further comprising the step of performing ligand exchange or modification in order to modify the surface functionalization of the nanoparticles.

5. The method of claim 2, wherein the nanoparticles are surface functionalized the first solvent and further comprising the step of performing ligand exchange or modification in order to modify the surface functionalization of the nanoparticles.

6. The method of claim 1, wherein the substrate unit is attached to a wafer and the step of dispersing comprises the steps of: liberating the substrate unit from the wafer by ultrasonicating the wafer-attached substrate unit in the first solvent for a length of time sufficient to liberate the substrate unit from the wafer, and removing the wafer from the resulting suspension.

7. The method of claim 1, wherein the length of time of the step of ultrasonicating is from 12 to 24 hours.

8. The method of claim 1, wherein the substrate unit is selected from the group consisting of semiconductors, metals, oxides, single-crystalline materials, poly-crystalline materials, amorphous materials, magnetic materials, and superconductive materials.

9. The method of claim 2, further comprising the step of adding at least one surfactant to the second solvent in order to surface functionalize the nanoparticles.

10. The method of claim 1, further comprising the step of functionalizing at least one surface of the nanoparticles by the steps of:
choosing the first solvent according to at least one chemistry related to an intended surface functionalization of the nanoparticles; and
performing chemical modification to replace any surface-bonded first solvent molecule with other functional groups to produce nanoparticles having the intended surface functionalization.

11. The method of claim 10, wherein the step of ultrasonicating further comprises the steps of:
adding at least one surfactant chosen according to at least one chemistry related to the intended surface functionalization into the suspension; and
continuing ultrasonication for a length of time sufficient to produce nanoparticles having at least one surface-bonded surfactant molecule; and
wherein the step of performing chemical modification further comprises the step of replacing any surface-bonded surfactant molecule with other functional groups to produce nanoparticles having the intended surface functionalization.

12. The method of claim 1, further comprising the step of functionalizing at least one surface of the nanoparticles by the steps of:
adding at least one surfactant chosen according to at least one chemistry related to an intended surface functionalization of the nanoparticles into the suspension; and
continuing the step of ultrasonicating for a length of time sufficient to produce nanoparticles having at least one surface-bonded surfactant molecule.

13. The method of claim 12, further comprising the step of performing chemical modification to replace any surface-bonded surfactant molecule with other functional groups to produce nanoparticles having the intended surface functionalization.

14. The method of claim 2, further comprising the step of functionalizing at least one surface of the nanoparticles by the steps of:
choosing the first or second solvent according to at least one chemistry related to an intended surface functionalization of the nanoparticles; and
performing chemical modification to replace any surface-bonded first or second solvent molecule with other functional groups to produce nanoparticles having the intended surface functionalization.

15. The method of claim 14, wherein the step of ultrasonicating further comprises the steps of:
adding at least one surfactant chosen according to at least one chemistry related to the intended surface functionalization into the suspension; and
continuing ultrasonication for a length of time sufficient to produce nanoparticles having at least one surface-bonded surfactant molecule; and
wherein the step of performing chemical modification further comprises the step of replacing any surface-bonded surfactant molecule with other functional groups to produce the nanoparticles having the intended surface functionalization.

16. A method for synthesizing nanoparticles having predetermined surface functionalization, comprising the steps of:
sonofragmenting at least one ultra-thin one-dimensional substrate unit, comprising a high-aspect ratio nanowire, in at least one solvent, the solvent being chosen according to suitability for sonofragmentation of the substrate and according to at least one chemistry related to the predetermined surface functionalization, for a length of time sufficient to produce nanoparticles having at least one surface-bonded solvent molecule; and
performing chemical modification to replace the at least one surface-bonded solvent molecule with other functional groups to produce the nanoparticles having the predetermined surface functionalization.

17. The method of claim 16, further comprising the steps of:
adding at least one surfactant chosen according to at least one chemistry related to the predetermined surface functionalization into the substrate-containing solvent; and
continuing sonofragmenting for a length of time sufficient to produce nanoparticles having at least one surface-bonded surfactant molecule; and
wherein the step of performing chemical modification further comprises the step of replacing any surface-bonded surfactant molecule with other functional groups to produce the nanoparticles having the predetermined surface functionalization.

18. The method of claim 16, further comprising the step of performing solvent exchange with a second solvent to produce a solution of synthesized nanoparticles dispersed in the second solvent.

19. The method of claim 18, wherein the second solvent is chosen according to at least one chemistry related to the predetermined surface functionalization of the synthesized nanoparticles.

20. The method of claim 16, wherein the step of sonofragmenting further comprises the steps of:
dispersing the at least one ultra-thin substrate in the at least one solvent to form a suspension; and
ultrasonicating the suspension for a length of time sufficient to fragment the at least one substrate, producing a plurality of single nanoparticles dispersed in the solvent.
